(19) United States
(12) Patent Application Publication
(10) Pub. No.: US 2019/0116198 A1
(43) Pub. Date: Apr. 18, 2019

(54) Method For Model Checking On The Design Of Security checking software Of Safety-critical Distributed Storage System

(71) Applicant: Wise Network Science and Technology Consultancy Limited, HONG KONG (HK)

(72) Inventor: MENG MENG, HONG KONG (HK)

(73) Assignee: Wise Network Science and Technology Consultancy Limited

(21) Appl. No.: 16/103,222

(22) Filed: Aug. 14, 2018

Related U.S. Application Data
(63) Continuation-in-part of application No. 15/784,240, filed on Oct. 16, 2017, now abandoned.

(51) Int. Cl. H04L 29/06; G06F 8/35

(52) U.S. Cl. CPC H04L 63/1433; H04L 63/20; G06F 8/35

(57) ABSTRACT

A method for using an advanced software engineering methodology on the design of security checking software for safety-critical distributed storage system consisting of multiple server clusters, wherein the one or more programs is executable by at least one processor of a checking device to make security checking of safety-critical distributed storage system, the method comprising: building statically and dynamically formal model of process of security checking; based on model checking, verifying whether checking software designed according to the model meets the preset safety conditions, in which the safety conditions include featured conditions. This method also provides a symbolized methodology for the running of checking process, after symbolization, the method will prove the safety conditions via specific algorithms.

### CROSS-REFERENCE TO RELATED APPLICATIONS

This application is a continuation in part of U.S. utility patent application Ser. No. 15/784,240 with a filing date of Oct. 16, 2017. The content of the aforementioned applications, including any intervening amendment thereto, are incorporated herein by reference.

### FIELD OF THE DISCLOSURE

Embodiments of the present disclosure generally relate to Internet communication, and more particularly to method for model checking on the design of security checking software of safety-critical distributed storage system.

### BACKGROUND OF THE DISCLOSURE

“Smart city” system provide citizens public convenience and efficient public services in many areas based on sensor networks, combined with massive data, cloud computing, artificial intelligence analysis technology. For the “Smart city” system which is a distributed storage system, it is important to make an intelligent security c of the distributed storage system (server clusters), considering the protection of citizens' privacy, the security of data saved in the server by financial institutions or government departments. That is, the security checking of safety-critical distributed storage system should be safety, as well as the security checking software itself should be credible. The invention aims to make security checking of safety-critical distributed storage system and provide credible security checking software so that effectively guarantee the safety of the checking and the checking process itself.

### SUMMARY OF THE DISCLOSURE

In accordance with one aspect of the disclosure, a checking device for security checking of safety-critical distributed storage system consisting of multiple server clusters, comprising at least one processor, at least one storage system in signal communication with the processor, one or more programs stored in the storage system and executable by the processor, the one or more programs comprising instructions for: sending customized Shell checking scripts to each checked server; drives the corresponding checking CSCI on the checked server to check corresponding function items via the Shell checking scripts and save the checking results as a checking result file; accessing the checking result file; generating a static checking report of the checked server after comparison between the checking result file and table file stored in a checking database;

generating a final static checking report of the distributed storage system by synthesizing all the static checking reports of all the checked servers.

In accordance with another aspect of the disclosure, a method for security checking of safety-critical distributed storage system consisting of multiple server clusters, applied in a checking device, the method comprising: sending customized Shell checking scripts to each checked server; drives the corresponding checking CSCI on the checked server to c via the Shell checking scripts and save the checking results as a checking result file; accessing the checking result file; generating a static checking report of c after comparison between the checking result file and table file stored in a checking database; generating a final static checking report of the distributed storage system by synthesizing all the static checking reports of all the checked server.

In accordance with another aspect of the disclosure, a method for security verification of one or more programs of security checking of safety-critical distributed storage system consisting of multiple server clusters, wherein the one or more programs is executable by at least one processor of a checking device to make security checking of safety-critical distributed storage system, the method comprising: building statically and dynamically formal model of process of security checking; based on model checking, verifying whether checking software designed according to the model meets the preset safety conditions, in which the safety conditions include the following conditions:

First safety condition: during checking process are being executed, the data and scripts being transformed between checking system and being checked system can't be accessed or gotten by third software.

Second safety condition: after security checking, no external redundant data and files exist on the safety-critical distributed storage system;

Third safety condition: after security checking, no other relevant information of the safety-critical distributed storage system exists on the checking device except the checking report.

Other advantages and features will be apparent from the following detailed description when read in conjunction with the attached drawings.

### BRIEF DESCRIPTION OF THE DRAWINGS

For a more complete understanding of the disclosed method and checking device, reference should be made to the embodiments illustrated in greater detail in accompanying drawing, wherein:

FIG. 1 is a diagrammatic view of an application environment of one embodiment of method for security checking of safety-critical distributed storage system in accordance with the present disclosure;

FIG. 2 is a block diagram of an embodiment of function module of the checking device;

FIG. 3 is a flowchart of one embodiment of method for security checking of safety-critical distributed storage system in accordance with the present disclosure;

FIG. 4 is a flowchart of one embodiment of sending customized Shell checking scripts to each checked server, the flowchart gives details of step S301 in FIG. 3;

FIG. 5 is a flowchart of one embodiment of accessing the checking result file, the flowchart gives details of step S303 in FIG. 3;

FIG. 6 is a flowchart of one embodiment of drives the corresponding checking CSCI on the checked server to check corresponding function items, the flowchart gives details of step S302 in FIG. 3;

FIG. 7 is another flowchart of one embodiment of method for security checking of safety-critical distributed storage system in accordance with the present disclosure;

FIG. 8 is a diagrammatic view of the statically formal model of the security checking software in accordance with the present disclosure;

FIG. 9 is a diagrammatic view of the dynamically formal model of the security checking software in form of windows tree in accordance with the present disclosure;

FIG. 10 is a diagrammatic view of the state flow chart of the checking process in accordance with the present disclosure.

FIG. 11 is a diagrammatic view of TS, which describe the Transition System of normal state sequence for Checking System.

FIG. 12 is a diagrammatic view of NFA, which describe the Nondeterministic finite automation of abnormal state sequence for Checking System.

It should be understood that the drawings are not necessarily to scale and that the disclosure embodiments are sometimes illustrated diagrammatically and in partial views. In certain instances, details which are not necessary for an understanding of the disclosed system, or which render other details difficult to perceive, may have been omitted. It should be understood, of course, that this disclosure is not limited to the particular embodiments illustrated herein.

### DETAILED DESCRIPTION OF THE DISCLOSURE

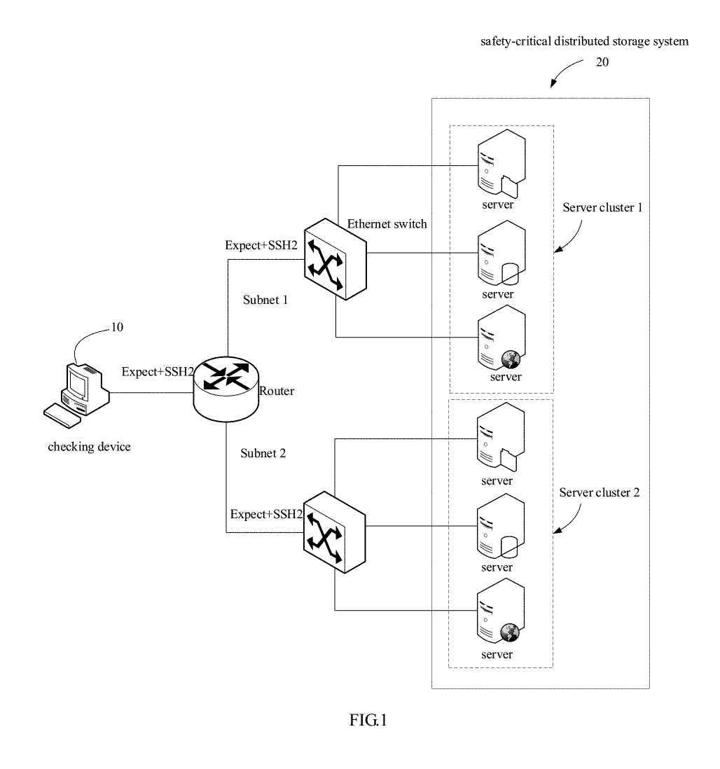

Referring now to the drawing, and with specific reference to FIG. 1, FIG. 1 is a diagrammatic view of an application environment of one embodiment of method for security checking of safety-critical distributed storage system in accordance with the present disclosure. FIG. 1 shows the checking device 10 that installed a security checking software to make a security checking of safety-critical distributed storage system 20. The safety-critical distributed storage system 20 includes multiple server clusters, such as server cluster 1 and server cluster 2 shown in FIG. 1. The system 20 is a large-scale distributed storage system. Each subsystem with similar function, such as radar subsystem, display and control subsystem of the civil aviation electronic system, special subsystem the banking system, is connected via Ethernet switch to form a group of server cluster. Multiple server clusters are connected routers, divided into different subnets. There is no interconnection between different subnets. The security checking process of servers belongs to all servers is directly controlled by the checking device 10. The CSCI (Computer Software Configuration Item) of the checked system (server) has no migration and change during the checking process. The system 20 is only linked to other device outside the subnet via SSH (Secure Shell) and SCP (Secure Copy) network interface, that is, the checking device can only access and operate the CSCI of the system 20 via the two network interface. Expect is a software suite for automating interactive tools, with the help of Expect, the interaction process can be written on a script to automate it. SSH login, FTP login and so on, all conform to the definition of interaction and a SSH2 connection between the checking device 10 and the checked server can be establishing via the expect tool.

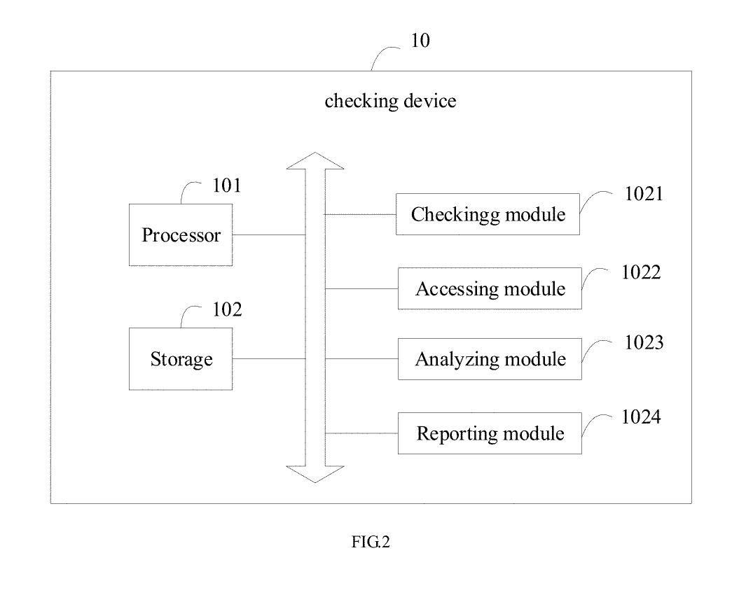

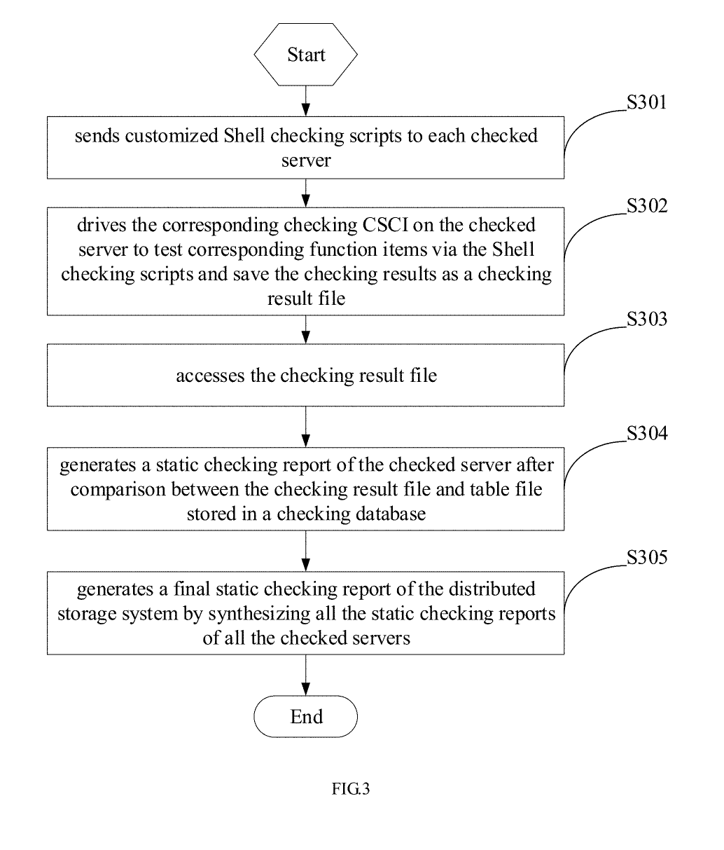

Referring now to the drawing, and with specific reference to FIG. 2-3, FIG. 2 is a block diagram of an embodiment of function module of the checking device 10. FIG. 3 is a flowchart of one embodiment of method for security checking of safety-critical distributed storage system in accordance with the present disclosure. In FIG. 2, the checking device 10 includes at least one storage system 102, at least one processor 101, a checking module 1021, a accessing module 1022, a analyzing module 1023 and a reporting module 1024. The storage system 102 connects with the processor 101. The modules of the checking device 10 comprises one or more software programs in the form of computerized codes, existing as a security checking software. The storage system 102 stores the computerized codes, and the processor 101 executes instructions of the computerized codes to provide functions for the modules 1021-1024 The checking device 10 can execute the method for security checking of safety-critical distributed storage system shown in FIG. 3:

In S301, the checking module 1021 sends customized Shell checking scripts to each checked server;

In S302, the checking module 1021 drives the corresponding checking CSCI on the checked server to check corresponding function items via the Shell checking scripts and save the checking results as a checking result file;

In this embodiment, the checking process is written on scripts as customized Shell checking scripts. The customized Shell checking scripts are send to the checked server as checking scripts in the checked server. Herein the checked server can be any server of the server clusters of the system 20. The checking module 1021 will checking every server of the of the server clusters of the system 20 until all the servers are checked. During the security checking process, checking of all function items are accomplished by driving the checking scripts on the checked server to be executed, and the execution of the checking scripts is composed of execution of a group of Linux API ((application access interface). Thus, the entire security checking process can be broken down into implementation processes of a set of Linux API. Among the Linux API, a set of API that can be implemented to perform individual checking task is be considered as a CSCI, in that, one CSCI consists of a set of API. As for a function item, there are corresponding checking CSCI to accomplish the checking of the function item, and the checking CSCI can be driven when the Shell checking scripts is executed.

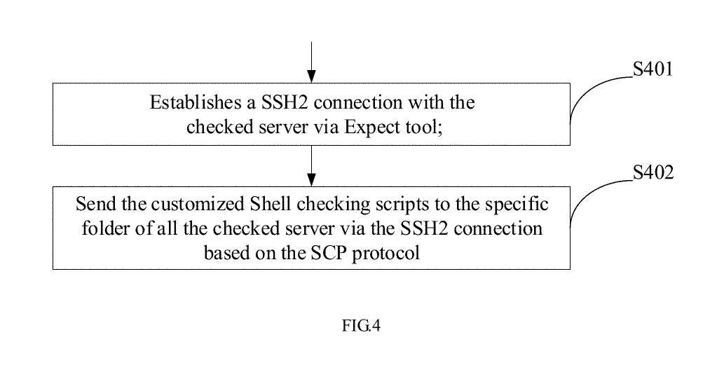

Referring now to the drawing, and with specific reference to FIG. 4. In detail, the step S301 further comprises the following steps S401 and S402.

In S401, the checking module 1021 establishes a SSH2 connection with the checked server via Expect tool;

In S402, the checking module 1021 sends the customized Shell checking scripts to the specific folder of all the checked server via the SSH2 connection based on the SCP protocol.

In this embodiment, the system 20 can only be accessed and checked via SSH and SCP network interface, so that the connection between the checked server and the checking device 10 should be a SSH connection, which can be established via the Expect tool. Herein in this embodiment the SSH connection is a SSH2 (SSH version 2) connection. The checking accesses the checked server via authentication using “public key” and password. Through the SSH2 connection, the checking module 1021 can send the customized Shell checking scripts the specific folder of the checked server via the Expect tool, and the transmission is based on the SCP (Secure Copy). Here, SSH2 connection, SCP can ensure the safety of data transmission during checking, matching the safety-critical requirement of the system 20. The specific folder is created in the checked server to save the checking scripts and checking data temporarily, all data and files produce during checking would be saved in the specific folder.

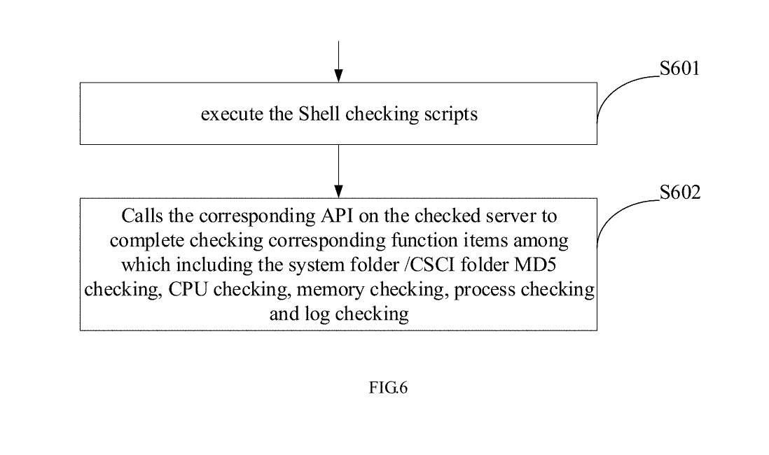

Referring now to the drawing, and with specific reference to FIG. 6. In detail, the step S301 further comprises the following steps S601 and S602.

In S601, the checking module 1021 executes the Shell checking scripts;

In S602, the checking module 1021 calls the corresponding API on the checked server to complete checking corresponding function items among which including the system folder/CSCI folder MD5 checking, CPU checking, memory checking, process checking and log checking.

In this embodiment, one CSCI consists of a set of API. As for a function item, there are corresponding checking CSCI to accomplish the checking of the function item, and the checking CSCI can be driven when the Shell checking scripts is executed by calling the corresponding API. The checking function items includes the system folder /CSCI folder MD5 checking, CPU checking, memory checking, process checking and log checking.

In S303, accessing the checking result file;

In this embodiment, after checking, the checking module 1021 produces a checking result file saved in the specific folder. The accessing module 1022 get the checking result file in the checked server via sending corresponding to each one of the checked server via the Expect tool, to drive all the checked server transfer the checking result file to the checking device 10. The transmission is also based on the SCP to ensure the safety of data.

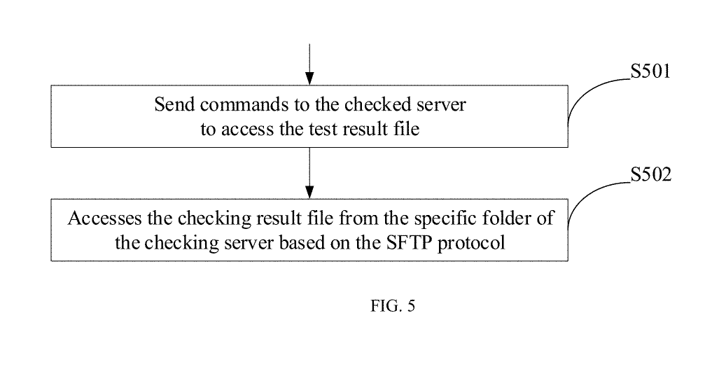

Referring now to the drawing, and with specific reference to FIG. 5. In detail, the step S303 further comprises the following steps S501 and S502.

In S501, the accessing module 1022 sends commands to the checked server to access the checking result file;

In S502, the accessing module 1022 accesses the checking result file from the specific folder of the c based on the SCP protocol.

In this embodiment, as the checking result file is save in the specific folder, the accessing module 1022 first accesses the specific folder to get the checking result file. The commands can be SCP commands, which originate a file transmission between the checking device 10 and the checked server remotely via authentication using “public key” and password. All the interaction commands are transferred via the SCP network interface, which is generally port 22. The accessing module 1022 accesses the checked server via port 22 and gets the checking result file from the specific folder.

In S304, generating a static checking report of the checked server after comparison between the checking result file and table file stored in a checking database;

In S305, generating a final static checking report of the distributed storage system by synthesizing all the static checking reports of all the checked servers.

In this embodiment, the analyzing module 1023 compares the checking result file and the table file. Here the table file is a checking results reference table stored in a checking database of the checking device or networks, which records the checking result of different function item according to the checking data. According the checking data recorded in the checking result file and the table file, the analyzing module 1023 can affirm the result of each function item of the checked server, then the reporting module 1024 can generating a static checking report of the checked server. After static checking reports of all the checked server are generated, the reporting module 1024 synthesizes all the static checking reports and gets a final static checking report of the distributed storage system. The final static checking report is an integrated report of the checking of the system 20.

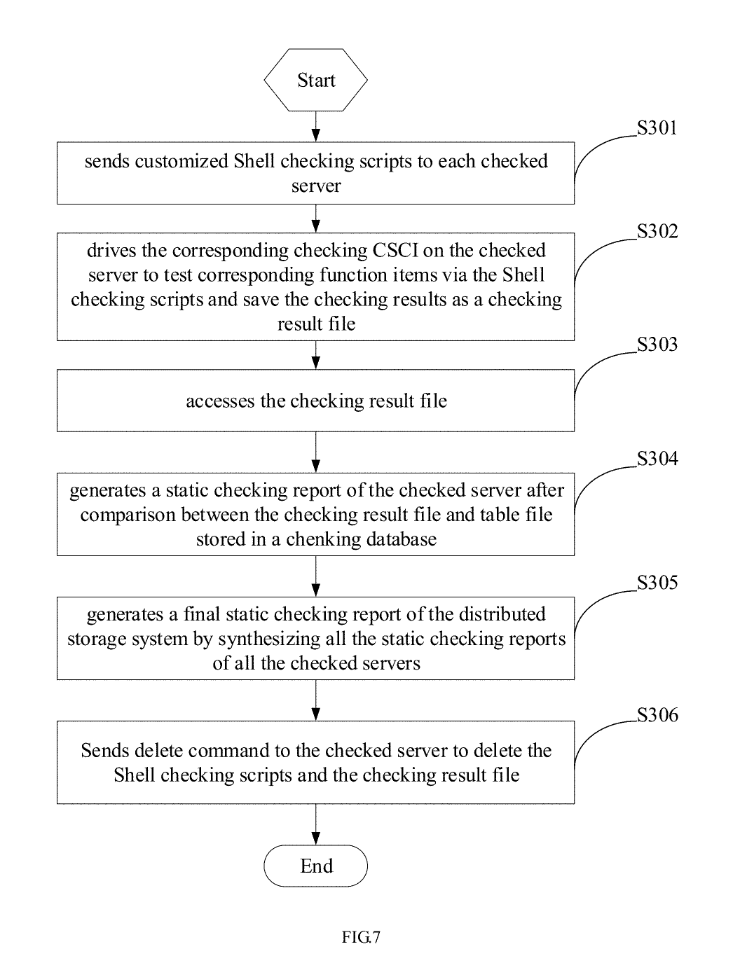

Referring now to the drawing, and with specific reference to FIG. 7, in this embodiment, the method further comprises step S306 after step S305.

In S306, the checking module 1021 sends deleting command to the checked server to delete the Shell checking scripts and the checking result file.

In the embodiment, as the system 20 is safety-critical system which requires that no external redundant data and files exist on the safety-critical distributed storage system after checking, so the Shell checking scripts and the checking result file, or other data or file that produced during checking, should be deleted after finishing checking. The checking module 1021 sends deleting command to the checked server to delete all the data and file produced and saved in the specific folder to make sure that nothing is left in the checked server because of the checking.

In this embodiment, the checking process of the system 20 is making by the checking device 10 that installed a security checking software. And the checking process meets the following security requirements:

1. the security of data transmission between the checking system and the mission system is safety during the execution of the checking, that is, whether to adopt the secure network communication protocol and interface, so as to ensure that the transmission data is not stolen by the outside world.

As the connection established between the checking device 10 and the checked server is a SSH2 connection and the data transmission during checking is based on SCP or SFTP, which all require authentication using “public key” and password, the checking meets security requirement 1.

2. after checking, no external redundant data and files exist on the safety-critical distributed storage system.

3. after checking, no other relevant information of the safety-critical distributed storage system exists on the checking device except the checking report.

As for security requirement 2 and 3, they have been validated in the software design phase of the security checking software. The validation process will be described in detail below.

Referring now to the validation process, a method for security verification of security checking software of the system 20 is offered in other embodiment of the disclosure, a security checking process is make by the executing the one or more programs (the security checking software), the method comprising the following steps:

Step 1: building statically and dynamically formal model of process of security checking;

Step 2: based on model checking, verifying whether the one or more programs designed according to the model meets the preset safety conditions, these conditions are defined in SUMMARY.

In this embodiment, the statically formal model of the security checking software is defined as following:

Define 1 (API): API=(api_Name Iᵢₙ, Iₒᵤₜ, Bᵢₙ, Bₒᵤₜ); each parameter is explained as follows:

1) api_Name is the interface name and is the unique identifier for each API.

2) Iᵢₙ={P₁, P₂, . . . Pₘ}, (m≥0) represents the input of the API and Pm is parameter of Iin.

3) Iₒᵤₜ={P₁, P₂, . . . Pₙ}, (n≥0) represents the output of the API and Pn is parameter of Iout.

4) Bᵢₙ represents the constraint set of the input Iᵢₙ.

5) Bₒᵤₜ represents the constraint set of the output Iₒᵤₜ.

For example, when making MD5 (function item) checking of a file, the API called named md5sum, the input parameters is the file name in the form of the String type, the output parameters is the MD5 code of the file, according to definition 1, we can get a formal definition of the API is: APImd5sum=(md5sum, {String}, {md5Code}, ε, {.md5}).

Define 2 (performance index PI): PI=(r_Name, {(p, b)}); each parameter is explained as follows:

1) r_Name represents the identity of the resource;

2) (p, b) ∈P×B, P={p₁, p₂, p₃, . . . , pₙ} (n>0) represents the set of the attribute name of resource, B={b₁, b₂, b₃, . . . , bₙ} (n>0) represents the set of the attribute values of resource, bᵢ[lower, upper], lower represents the lower limit, and upper represents the upper limit.

For example: for API of the above checking of the MD5 function item, its performance index requires that the execution time is less than or equal to 1 milliseconds, according to the definition 2, it can be written as PImd5sum=(md5sum, {(microminute, [0,1])}).

Define 3 (configuration file CONF): CONF=(Nameconf, {(a, v)}); among them:

1) Nameconf indicates the identity of the file;

2) (a, v) ∈A×V. A={a₁, a₂, . . . aₜ} (t>0) represents the set of the attribute name of file, V={v₁, v₂, . . . vᵤ} (u>0) represents the set of the attribute values of file.

For example, a configuration file (script) driving to make MD5 checking of a checked server, the name of the configuration file is calmd5.sh, the saved location is /home/tempdata, the size is 0.5 KB, the host IP address is 192.168.1.107, and script ID is 101, according to definition 3, it can be written as (calmd5, {(type, .Sh), (size, 0.5 KB (location), /home/tempdata), (content, {ID:101, IP:192.168.1.107})})

Because each CSCI can be defined as a collection of API, the performance index (PI) that guarantees normal operation of the system and the configuration file (conf), the definition of CSCI can be obtained:

Define 4 (CSCI): CSCI=(Name_{csci}, API, PI_{csci}, CONF_{csci}); among them:
1) Name_{csci} indicates the identifier of the CSCI of the security checking software;
2) API indicates the set of API to the outside that the CSCI offer:
API={api₁, api₂ . . . apiₘ} (m>0);
3) PI_{csci} indicates the set of the performance index, PI_{csci}={pi₁, pi₂ . . . piₙ} (n>0);
4) CONF_{csci} represents the set of configuration files that the CSCI belongs to: CONF_{csci}={conf₁, conf₂, . . . conf_{q}} (q>0).

According to definition 4, a formal checking of CSCImd5sum for MD5 checking of system files (CSCI files) or individual files specified on the checked host (server) can be obtained: CSCI_{md5sum}=(CHECKMD5, API_{md5sum}, PI_{md5sum}, CONF_{md5sum}).

According to the function item required, the checking task subsystem (the corresponding CSCI) includes:

1) CSCI of MD5 checking of system files (CSCI files) or individual files specified on the checked server: CSCI_{checkmd5}.

2) CSCI of checking of the CPU utilization rate of the checked server: CSCI_{cpu}.

3) CSCI of checking of the memory utilization of the checked server: CSCIₘₑₘ.

4) CSCI of checking of the disk utilization of the checked server: CSCI_{log}.

5) CSCI of checking of the log of the checked server: CSCI_{disk}

6) CSCI of checking of the running process of the checked server: CSCI_{proc}.

7) CSCI of removal of the specific folder that stores checking data of the checked server CSCIᵣₑₘₒᵥₑ.

8) CSCI of transmission of script: CSCI_{expect}.

According to all these the definitions above, the formal definition of the security checking software can be obtained:

Define 5 (SS_{checkhost}): SS_{checkhost}=(CHECKHOST, CSCI_{checkhost}, API_{checkhost}, PI_{checkhost}, CONF); among them:

CSCI_{checkhost}={CSCI_{checkmd5}, CSCI_{cpu}, CSCIₘₑₘ, CSCI_{disk}, CSCI_{log}, CSCI_{proc}, CSCIᵣₑₘₒᵥₑ, CSCI_{expect}};

API_{checkhost}=API_{md5sum}∪API_{cpu}∪APIₘₑₘ∪API_{disk}∪API_{proc}∪API_{log}∪APIᵣₑₘₒᵥₑ∪API_{expect}

PI_{checkhost}=PI_{md5sum}∪PI_{cpu}∪PIₘₑₘ∪PI_{disk}∪PI_{proc}∪PI_{log}∪PIᵣₑₘₒᵥₑ∪PI_{expect}

CONF_{checkout}=CONF_{md5sum}∪CONF_{log}∪CONF_{expect}.

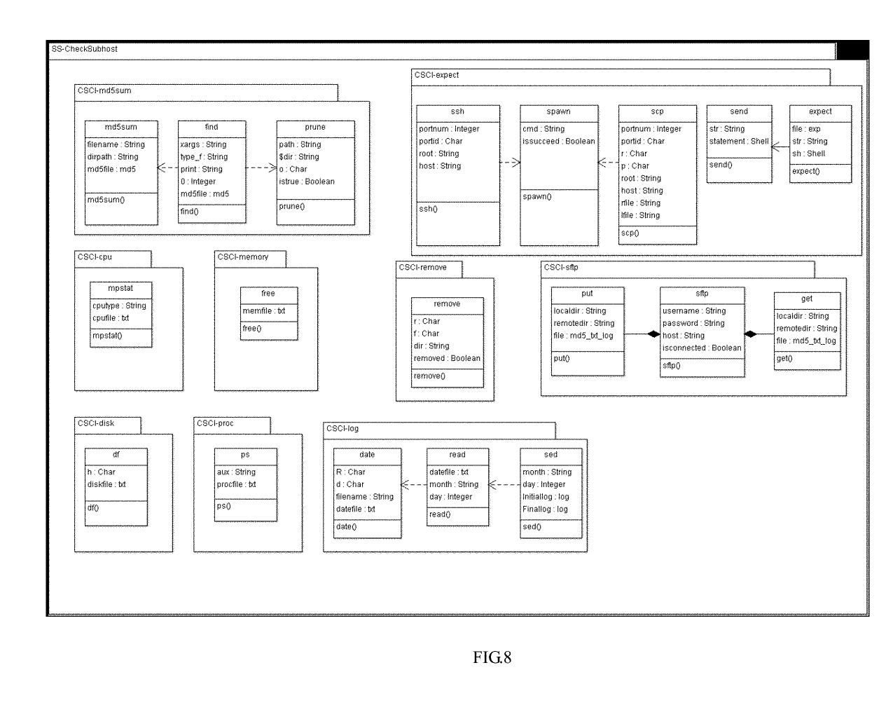

Referring now to the drawing, and with specific reference to FIG. 8, the statically formal model of the security checking software is as shown in FIG. 8.

In this embodiment, the dynamically formal model of the security checking software is defined as following:

Define 6 (window W): W=(APIₜ), among them:

APIₜ represents the API set that can be called when the checking process runs to the time point of t, wherein the quantity of API is from 0 to more.

For example, when the checking process runs to checkingMD5 checking checking of system files (CSCI files) or individual files specified on the checked server, it can be represented as “W=APIₜ_{_}_{calmd5}=API_{md5sum}” according to definition 1.

Define 7 (event E), E=(Event_Name, Precondition, API, Parameter); among them:

1) Event_Name represents the name of the event.

2) Precondition indicates the preconditions of the event, which is a Boolean expression that can be executed only when the preconditions are true.

3) API: operation set when events are triggered, which can be null.

4) Parameter: parameters required when calling the set of API when the event is triggered.

For example, an event corresponding to the definition 6 of t=t_calmd5 in 7 can be defined as: e₁=(Calmd5, (bash, calmd5.sh), APIt_calmd5, dirname∥filename). A sequence of one or more events is defined as events sequence: e=e₁e₂ . . . eₙ.

Because the checking does not involve the checking of internal functions of the checked server and only checks whether the operating environment of the checked server can ensure the normal execution of the checked server, so the whole process of the checking can be considered as process of calling API sequence by the chenked server. That is, the checking process is equivalent to the orderly flow among different API. Different input parameters will trigger different API calls and generate different flow directions. Therefore, the tree structure can be used to describe the checking process of the security checking software, that is, the windows tree, which is defined as follows:

Define 8 (windows tree WT_Check): WT_Check=(W, W₀, E, RW,E); among them:

1) W indicates the window set, w∈W indicates a node of windows tree.

2) w∈W indicates the initial window of the start of the checking process.

3) E indicates the set of events during the running of the windows tree, which is the set of events that are triggered during the flow among windows of the checked server.

RW, E∈W×W×E indicates the transfer between different window, for example, (wᵢ, wⱼ, e) ∈RW, E, indicates that e is event of windows wᵢ transferring to window wⱼ, wᵢ is the parent node of wⱼ.

During the execution of the security checking software, the checking process on each checked can be divided into 4 steps:

1) in the sendscript phase, the checking device 10 sends the checking scripts to customized Shell checking scripts to the specific folder of all the checked server via the Expect tool;

2) in the checkhost phase, the checking device 10 calls the corresponding API on the checked server, respectively, to complete the system folder /CSCI folder MD5 checking, CPU checking, memory checking, process checking and log checking;

3) in the getresultfile phase, the checking device 10 acquires the checking data on the the checked server via SCP;

4) in the remove phase, the checking device 10 sends deleting commands via the Expect tool to delete checking data and scripts reserved in the specific folder of all the checked server.

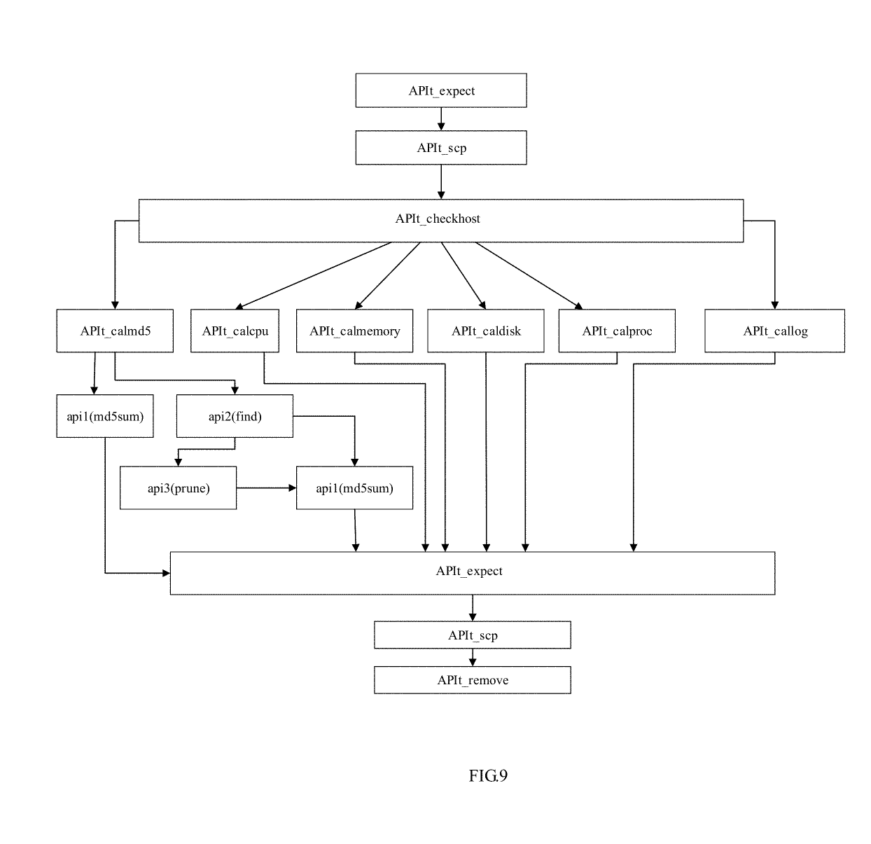

The corresponding windows tree of the checking process is shown in FIG. 9, which is the dynamically formal model of the security checking software.

Through the analysis of the above four steps, the state flow chart STG is defined as follows:

Define 9 (state flow chart, STG): STG=(S, S₀, E, R_{S, E}, F), among them:

1) S represents a finite set of all States in STG S₀ indicates the initial state, S₀∈S.

2) E represents a set of all events in STG, and E is a nonempty finite set.

3) R_{S, E} is a set of state transition functions in STG, δ: S×E→S

4) F is a set of termination state in STG F∈S.

Take the windows tree shown in FIG. 9 as an example, the state transition diagram of the checking task (function item) can be constructed by defining the task state of the system (server). For distributed storage system, checking scripts and checking results files (MD5, TXT, messages, etc.) are carried out in a fixed and ordered process. These data are collectively referred to as files, and the checking task can be defined as:

The checking task::=(checking process, checking files);

The checking task state::=(status of the process, status of the checking files); and checking process::=checking event sequence;

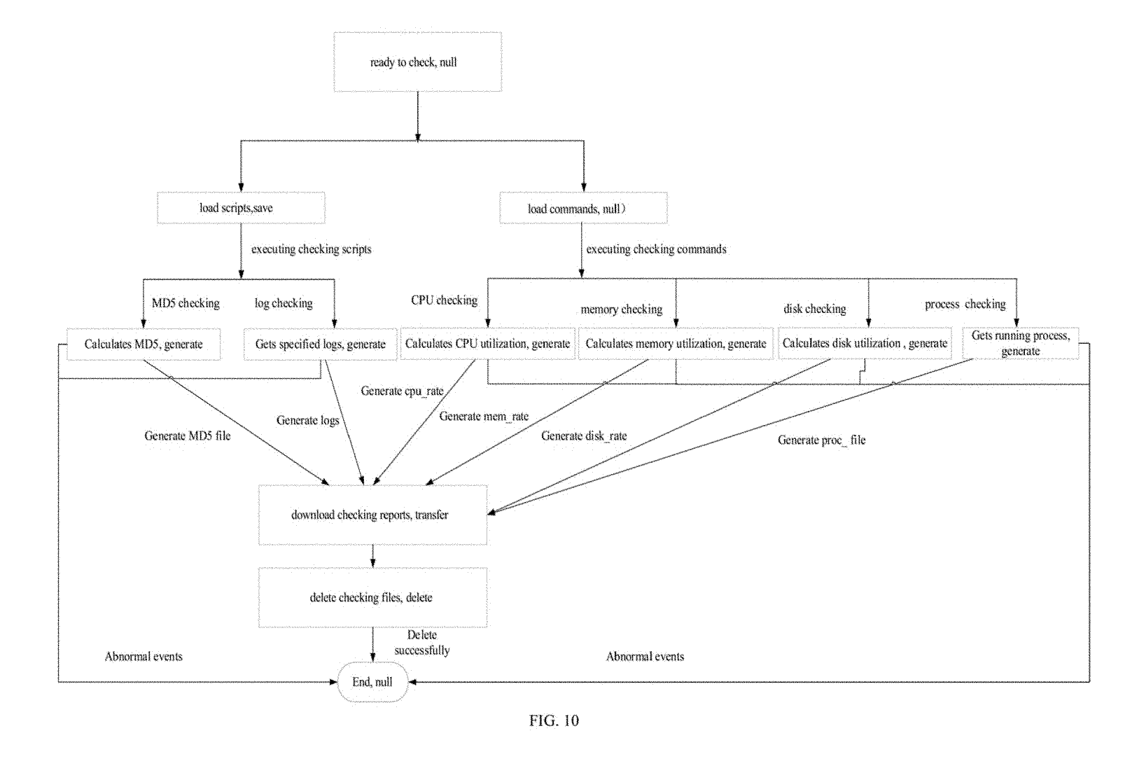

Through the analysis of the set of the status of the task, the state flow chart of the checking process is shown in FIG. 10.

Based on model checking, the verifying of whether the security checking software designed according to the model meet the preset safety conditions is as follows:

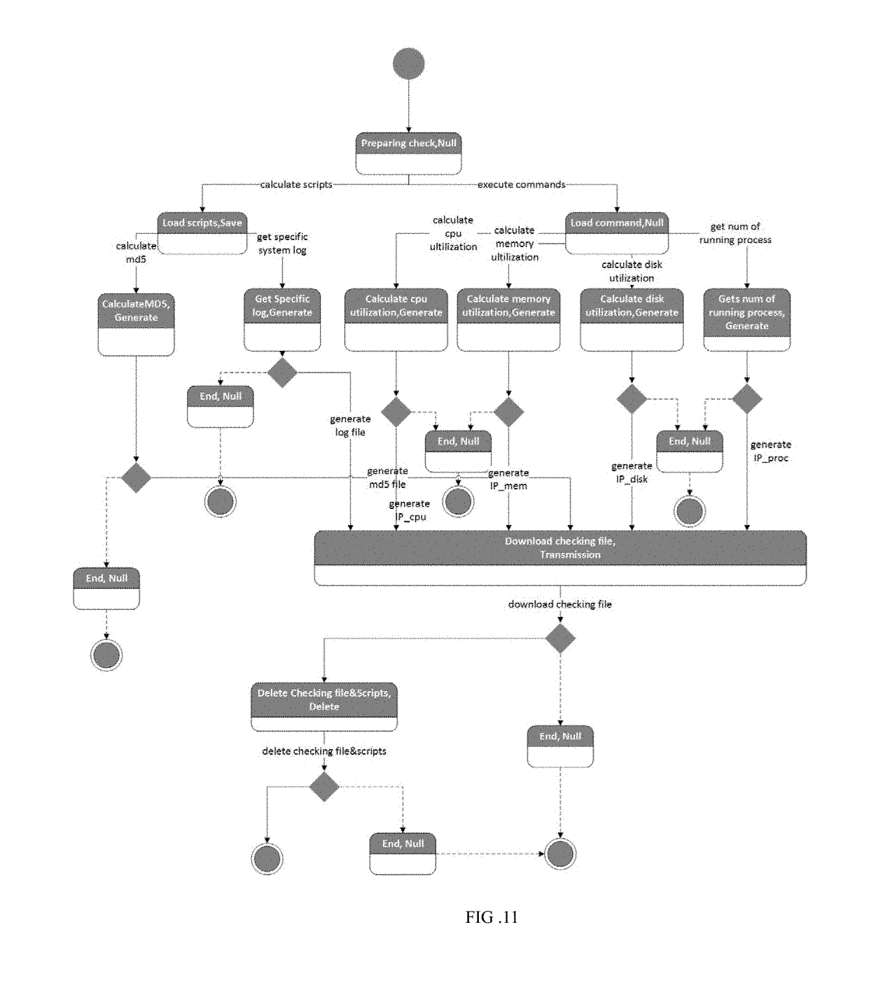

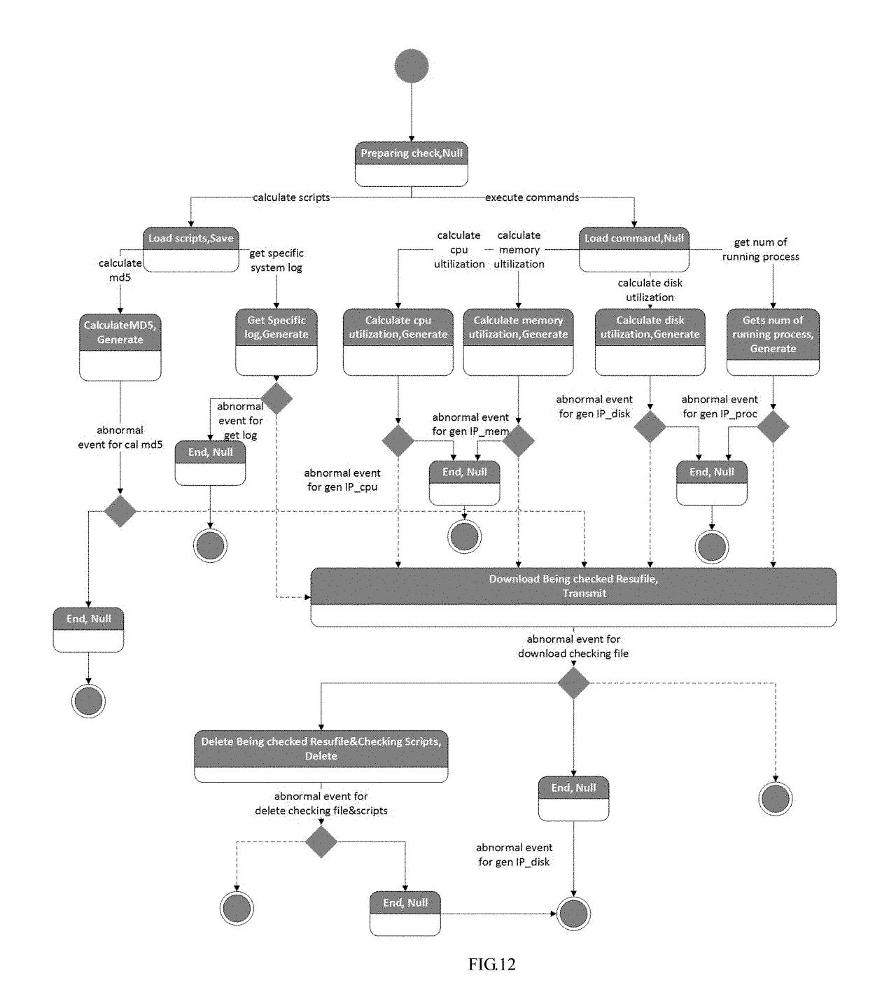

The set of normal state transition sequence and the set of abnormal state transition sequence of STG shown in FIG. 10 are rewritten as state transition system TS as shown in FIG. 11 and finite state machine NFA as shown in FIG. 12 respectively as follows:

Define 10 TS=(S, Act, →, I, AP, L), among them:

1) S represents the finite set of all States in the TS, and S=set of process state.

2) Act represents the set of all executable actions in the TS, and Act=process operations.

3)→⊆S×Act×S, represents {set of process state}×{process operations}×{set of process state}. A rule of the “→” represents a change in state, for example, ready to check, <load checking scripts→Load scripts.

4) I⊆S, the set of initial state in S, in this case, I={ready to check}.

5) AP: propositions in TS. For example, “calmd5.sh resides being checked system” is an atomic proposition AP, that is, the proposition can not be further divided.

6) L: S→2^{AP}: the power set of which the set of state contains AP (all subsets of AP including set family consisting of empty set and complete set).

Define 11 NFA=(Q, Σ, δ, Q₀, F), among them:

1) Q={ready to check, load scripts, load commands, gets specified logs, calculates MD5, calculates CPU utilization, calculates memory utilization, calculates disk utilization, gets running process, end}.

2) E={calmd5.sh, callog.sh, mpstat, free, df, ps, abnormal generate events U abnormal transmit events∪abnormal delete events}. Herein, “calmd5.sh” and “callog.sh” are checking scripts, “mpstat”, “free”, “df” and “ps” are checking commands.

δ=Q×Σ, for example: “δ (calculates MD5, cal/gen md5 abnormal event)=end” represents a state migration of NFA.

3) Q₀⊆Q, represents the initial state of NFA, Q₀={ready to check}.

4) F⊆Q, represents the accepted termination state of NFA, F={abnormal end}.

5) [symbol] (NFA)={w∈Σ*, |δ (Q₀, w) ∈F}=

{δ(calculates MD5, abnormal cal/gen md5 events)=end, δ(gets specified logs, abnormal get/gen logs events)=end, δ(calculates CPU utilization, abnormal calCPUUtil events)=end, δ(calculates memory utilization, abnormal calMemUtil events)=end, δ(calculates disk utilization, abnormal caldiskUtil events)=end, δ(gets running process, abnormal get proc events)=end, δ(Download Being Checked Resufile, abnormal download events)=end, δ(Delete Being Checked Resufile & Checking Scripts, abnormal delete events)};

[symbol] (NFA) contains the disjunctive formula of AP, therefore, the preset safety conditions is met if and only if the intersection of all reachable sequences of the TS and [symbol] (NFA) is null.

According to definition 10 and 11, the verifying of whether the security checking software designed according to the model meets the preset safety conditions is defined as follows:

Define 12: TS|=Psafe only if Tracefin(TS)∩ [symbol] (NFA)=ø

Assumes that S is a set of Being checked result files and script files available of the checked server on the checking device.

BadPref(Psafe2) means abnormal events prefix for Psafe2, BadPref(Psafe2)={2^{AP}};

BadPreftPasfe3) means abnormal events prefix for Psafe3, BadPref(Psafe3) {2^{AP}};

BadPref(Psafe2)∪BadPref(Psafe3)= [symbol] (NFA); (the specific elements of 2^{AP} are depended on specific route of NFA)

According to the definition above, when the second safety condition is always met if and only if Tracefin(TS)∩BadPref(Psafe2)=ø;

when the third safety condition is always met if and only if Tracefin(TS)∩BadPref(Psafe3)=ø.

The verifying of the safety conditions can be proved via the preset algorithms according to the formulas above.

For the First safety condition, the using of SSH2 and SCP during checking process can ensure the safety of data and scripts.

For the Second safety condition, the verifying algorithms (algorithms 1) is as follows:

```
Input: Case:case_set[ ],
R-s: r-s_set[ ],
R_s: r-s_stack[ ],
  ::={w∈Σ*,|δ(Q₀,w)∈F}
Output: Boolean(True/False)
Verify_Security_2(case[ ] Case_set, r-s_set[ ] R-s, r-s_stack[ ]R_s, )
{
int p_v_num=0;
for(i=1;i<=case_set[ ]→casenum;i++)
  {
      for(j=1;j<=case_set[i]→enum; j++)
      {
      if(S(case_set[i]→e[j])!=
      Q(NFA)(delete Being Checked Resufile&Checking Scripts,delete)
        {
        if(!r-s_set(case_set[i])→p,v(e[j])∈(r_s_stack) )
        {
        r_s_stack.push(r-s_set(case[i])→p,v(e[j]) ));
        p_v_num++;
        }
      else
;
}
else
{
While(p_v_num!=0)
{
        r_s_stack.pop( );
        p_v_num−−;
}
}
if (!Is_empty(r_s_stack))
{
      return false;
}
}
return true;
}//end of function
```

In algorithm 1, S (case_set[i]→e[j]) represents the termination state of state changes caused by the occurring of the event e[j] corresponding to the checking case case_set[i]. Q (NFA) (delete Being checked files &Checking Scripts, Delete) represents the state of (delete Being checked files&Checking Scripts, Delete), which is one state of the state machine of NFA. When executing any checking case set, the checking process leads the state of (delete Being checked files&Checking Scripts, Delete), all resource status tiles produced during the executing of the case set (in stack) need to be deleted. As stack corresponds to the file set of the check system/server, the Second safety condition is met on each checking pass if and only if the stack is empty after this checking path being executed. If and only if when all checking path being executed, the safety conditions 2 is met, that is the safety condition 2 is met in checking process.

For the Third safety condition, the verifying algorithms (algorithms 2) is as follows:

```
Input: Case:case_set[ ],
R-s: r-s_set[ ],
            R_s: r_s_stack[ ],
            R_s: r_s_checkdata[ ], [symbol]
(NFA_Check)::={w∈Σ*,|δ(Q0,w)∈F}
Output: Boolean(True/False)
Verify_Security_3(case[ ] Case_set, r-s_set[ ] R-s, r-s_stack[ ]R_s, [symbol]
(NFA))
{
    for(i=1;i<=case_set[ ]→casenum;i++)
    {
        for(j=1;j<=case_set[i]→enum; j++)
        {
            if(S(case_set[i]→e[j]==
            Q(NFA)(Download Being Checked Resufile, Transmit) )
            {
                if(!r-s_set(case_set[i])→p,v(e[j])∈(r_s_stack) )
                {
                  r_s_stack.push(r-s(case_set[i])→p,v(e[j]) ));
              }
              else
            ;
        }
    }
    if(r_s_stack!=r_s_checkdata)
    {
        return false;
    }
return true;
}//end of function
```

In algorithm 2, When each set of checking cases are executed, the stack that corresponds to the set of files of the checking device after the set of checking case are executing. The checking process is proved to meet the third safety condition if all the being checked Result files in the stack is equal to the set of files that being permitted obtained by the checking device after all the set of checking cases are executed completely, otherwise the checking process cannot meet the Third safety condition.

Now the prototype verification of security checking software is performed as follows:

The prototype system is the same as the applicant environment in FIG. 1, as the checking process of each checked server executed by the security checking software is the same, so the actual security verification using VMWare and Linux system, simulating the implementation of security checking software in the checked system. the system. First, converts the STG shown in FIG. 10 to a state machine (TS) shown in FIG. 11 and an Nondetermenistic Finite Automation (NFA) shown in FIG. 12 that can be accepted by the checking device. The validation process is as follows:

1) During the execution of algorithm 1, implanted the counterexamples of the first safety condition in the execution path of first each checking case, wherein the counterexamples are: when the state transition is (delete Being checked Resufiles&Checking Scripts, delete)→(termination state), the action of deleting resource status files returns error information, the execution is failed. According to algorithm 1, it can determine that IsEmpty (r_s_stack) is disconfirmed, namely Tracefin(TS)∩BadPref(Psafe2)≠ø, in this case the second safety condition is not met. The analysis above illustrates that algorithm 1 can find out all cases that do not conform to the second safety condition. That is to say, algorithm 1 can prove that the checking process meets the second safety condition.
2) During the execution of algorithm 2, implanted the counterexamples of the second safety condition in the execution path of first each checking case, wherein the counterexamples are: when the state transition is (Download Being checked Resufile, transmit)→(termination state), the action of transferring data files of the checked system except the resource status files to the checking device returns error information, the execution is failed. According to algorithm 2, it can determine that r-s_stack ≡r_s_checkdata, there are redundant data obtained from the being checked system in the checking device or there are not correct data that can be permitted from being checked system. That is, Tracefin(TS)∩BadPref(Psafe3)≠ø At this point, the third safety condition is not met. It shows that algorithm 2 can find out all the cases which do not conform to the third safety condition. That is to say, algorithm 2 can prove that the checking process meets the third safety condition.

The conclusion of the prototype verification is: it can be proved that the second and third safety condition according to definition 12 is true via performing algorithm 1 and 2 in the environment of automatic checking prototype system.

While only certain embodiments have been set forth, alternatives and modifications will be apparent from the above description to those skilled in the art. These and other alternatives are considered equivalents and within the spirit and scope of this disclosure and the appended claims.

I claim:

1. A method for using an advanced software engineering methodology on the design of security checking software for safety-critical distributed storage system consisting of multiple server clusters, the server clusters comprising checked servers, the method comprising:
give formalized definition of safety condition Psafe2: after running of checking software, intersection between data set of being checked system which are uploaded from checking system and data set which are forbidden uploaded from checking system is empty;
give formalized definition of safety condition Psafe3: after running of checking software, intersection between data set of checking system which are downloaded from being checked system and data set which are forbidden to downloaded from being checked system is empty;
modeling the checking process via STG (State Transition Graph), which is in accordance with formalized software specification of checking software;
and then using TS (Transition System) to modeling the normal state transition sequences of the State Transition Graph, Transition System is a Finite State Machine which is comprised of all normal state traversal paths of State Transition Graph;
furthermore, using NFA (Nondeterministic finite automation) to modeling the abnormal state transition sequences of the State Transition Graph, which contains the Badpref(Psafe2) and Badpref(Psafe3), Badpref(Psafe2) and Badpref(Psafe3) means the set of all abnormal events lead to abnormal data resident in being checked system or checking system respectively, they also means abnormal state transition sequence that Psafe2 and Psafe3 not be fulfilled respectively;
drive checking software via Transition System, sending customized Shell checking scripts to each checked server, the checked server having corresponding checking Computer Software Configuration Items;
driving corresponding checking Computer Software Configuration Items on the checked server to check corresponding function items via the Shell checking scripts and save the checking results as a checking result file;
accessing the checking result file, using TS and NFA defined as above-mentioned to verify the intersection of TS and Badpref(Psafe3) is null set, that is, Psafe3 are being fulfilled when checking software running driven by TS;
generating a static checking report of the checked server after comparison between the checking result file and a table file stored in a checking database; and
generating a final static checking report of the distributed storage system by synthesizing all the static checking reports of all the checked servers.

2. The method for security checking for safety-critical distributed storage system consisting of multiple server clusters according to claim 1, wherein after generating the final static checking report of the distributed storage system, the method further including a step of sending a deleting command to the checked server to delete the Shell checking scripts and the checking result file.

3. The method for security checking for safety-critical distributed storage system consisting of multiple server clusters according to claim 2, wherein, the Computer Software Configuration Item consists of a set of application access interfaces, and the step of sending customized Shell checking scripts to each checked server further comprises:
executing the Shell checking scripts;
and calling corresponding application access interfaces on the checked server to complete checking corresponding function items.

4. The method for security checking for safety-critical distributed storage system consisting of multiple server clusters in claim 3, wherein, the step of sending customized Shell checking scripts to each checked server further comprises:
establishing a SSH2 connection with the checked server;
and sending the customized Shell checking scripts to a specific folder of all the checked server via the SSH2 connection based on a SCP protocol.

5. The method for security checking for safety-critical distributed storage system consisting of multiple server clusters in claim 4, wherein, the step of accessing the checking result file further comprises:
sending commands to the checked server to access the checking result file;
and accessing the checking result file from the specific folder of the checked server based on a SCP protocol.

6. A checking device for security checking for safety-critical distributed storage system consisting of multiple server clusters, the server clusters comprising checked servers, the checking device comprising:
a checking module, configured for sending customized Shell checking scripts to each of the checked servers, the checked server having corresponding checking Computer Software Configuration Item, and driving corresponding checking Computer Software Configuration Item on the checked server to check corresponding function items via the Shell checking scripts and save the checking results as a checking result file;
an accessing module, for accessing the checking result file;
an analyzing module, for performing a comparison between checking result file and a table file stored in a checking database;
and a reporting module, for generating a static checking report of the checked server after the analyzing module's comparison between the checking result file and a table file stored in a checking database, and for generating a final static checking report of the distributed storage system by synthesizing all the static checking reports of all the checked servers.

7. The checking device according to claim 6, wherein after generating the final static checking report of the distributed storage system, the checking module is further configured for sending a deleting command to the checked server to delete the Shell checking scripts and the checking result file, during the process of deleting, TS and NFA defined as above-mentioned are being used to verify the intersection of TS and Badpref(Psafe2) are Null set, that is, safety condition Psafe2 are fulfilled when checking software running driven by TS.

8. The checking device in claim 7, wherein, the Computer Software Configuration Item consists of a set of application access interfaces, and the checking module is further configured for executing the Shell checking scripts;
and calling corresponding application access interfaces on the checked server to complete checking corresponding function items.

9. The checking device according to claim 8, wherein, the checking module is further configured for:
establishing a SSH2 connection with the checked server;
and sending the customized Shell checking scripts to a specific folder of all the checked server via the SSH2 connection based on a SCP protocol.

10. The checking device according to claim 9, wherein, the accessing module is further configured for:
sending commands to the checked server to access the checking result file;
and accessing the checking result file from the specific folder of the checked server based on a SCP protocol.
